(19) United States
(12) Patent Application Publication
(10) Pub. No.: US 2009/0238947 A1
(43) Pub. Date: Sep. 24, 2009

(54) Calcium Fortified Food Product and Additive

(76) Inventors: Leonard Marcus Flendrig, Vlaardingen (NL); Clive Edward Marshman, Vlaardingen (NL); Krassimir Petkov Velikov, Vlaardingen (NL); Ingrid Winter, Graz (AT)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/085,616

(22) PCT Filed: Oct. 26, 2006
(86) PCT No.: PCT/EP2006/010323

§ 371 Date: Apr. 7, 2009

(30) Foreign Application Priority Data
Nov. 30, 2005 (EP) 05077741.6

(51) Int. Cl. A23L 1/304; A23L 1/305; A23J 7/00; A23J 1/20; A23J 1/14

(52) U.S. Cl. 426/648; 426/654; 426/662

(57) ABSTRACT

A food product which has been fortified in calcium content, having an calcium content of at least 5 ppm and comprising calcium-containing nanoparticles, wherein the nanoparticles are stabilised by means of a biopolymer and, if the biopolymer is a protein, do not contain a calcium complexing agent, provides good bioavailability and stability.

### FIELD OF THE INVENTION

The invention generally relates to the field of fortified food products. More in particular, it relates to the fortification of a food product with calcium. The invention also relates to an additive for the fortification and supplementation of food and other products with calcium and to a method of preparing the same.

### BACKGROUND TO THE INVENTION

Calcium is the most common element in the animal and human body. It is a major structural element in bones and teeth where it occurs mainly in the form of as hydroxyapatite. Furthermore, calcium plays a role in mediating the constriction and relaxation of blood vessels, nerve impulse transmission, muscle contraction, and the secretion of hormones, such as insulin. Calcium is also necessary to stabilise or allow for optimal activity of a number of proteins and enzymes.

Calcium deficiency was and remains a common nutritional problem not only in the developing world but also in the industrialized countries. For example, inadequate intake of dietary micronutrients causes several diseases. For example, a low blood calcium level usually causes chronic kidney failure, vitamin D deficiency, and low blood magnesium levels that occur mainly in cases of severe alcoholism. A chronically low calcium intake in growing individuals may prevent the attainment of optimal peak bone mass. Once peak bone mass is achieved, inadequate calcium intake may contribute to accelerated bone loss and ultimately the development of osteoporosis.

Since the human body does not produce minerals, it is totally dependent on an external supply of calcium, either nutritional or supplementary. The importance of adequate calcium intake is recognized during the whole life of the human being. The recommended daily allowance for calcium intake is from 210 to 1,300 mg per day, and is dependent on age and sex. Expectant and nursing mothers, infants, children and elderly people are in the group with higher requirements of calcium.

In general, water-soluble minerals used for supplements are likely to impair the stability of a food product. Hence, it cannot contain more than a certain amount of such water-soluble minerals. This also restricts their use as mineral supplements. Moreover, the peculiar bitter or metallic taste is also a problem for many food formats. In addition, multivalent metal ions such as calcium are particularly bitter and they can react with several proteins and polysaccharides causing precipitation and change in texture.

In general, water-insoluble minerals affect the stability and taste of the product less and high amounts can be added. However, the high specific gravity of minerals (generally as high as 1.5 or higher) causes them to sediment in a short time when dispersed in a liquid product such as milk, so that the stability and the appearance of food is adversely affected. Thus, the amount that can be added is still limited.

Furthermore, the use of mineral supplements in form of insoluble large particles can cause abrasion and severe damage of the mixing and processing equipment.

Calcium in the form of a water-soluble salt or complex can be added to food and/or beverages to provide the daily allowance. The main problems caused by calcium sources added to food and beverages are bitter taste and physico-chemical instabilities. For example, the addition of calcium to beverages, especially to plant protein containing drinks and beverages, can be very difficult. If highly or slightly soluble sources of calcium are used, interaction between the calcium and calcium sensitive ingredients, such as proteins, occurs. Thus, the addition of calcium chloride or other soluble calcium salts such as calcium lactate, calcium gluconate, calcium fumarate, calcium citrate, etc., cause drastic instabilities in plan protein containing liquid, semiliquid or solid products, after mixing with water or with other water containing liquid products.

As alternatives to the soluble sources of calcium, lead to an undesirable flavor and/or color and/or taste, insoluble calcium sources such as calcium carbonate, calcium phosphate, etc. may be used. These forms of calcium cause little chemical instabilities, but added to drinks and liquid beverages they may cause severe sedimentation, which could make the mineral not available to the consumer because it remains in the package, or loss of transparency, if added to clear products, or color change if added to colored products.

So far, few attempts have been made to simultaneously address these very complex issues. For example, EP-B-870 435 (Taiyo Kagaku) discloses a mineral-containing composition having improved dispersion stability and comprising enzymatically decomposed lecithin and water-insoluble mineral, preferably calcium carbonate, calcium phosphate or calcium pyrophosphate. The use of enzymatically decomposed lecithin is essential for achieving the desired dispersion stability. A major drawback of these compositions is that the emulsifier lecithin has to be present. It is known that lecithin has not very pleasant taste. In addition, the use of emulsifier makes the product particularly costly and not appealing to the consumer.

Products containing lecithin are “Generally Recognised As Safe” (GRAS) under 21 CFR 184.1400 and specifications of the Food Chemicals Codex. Lecithin products that have been modified sometimes require special labelling. For example, when enzymatically modified, the phrase “Enzymatically Modified Lecithin” should appear on labelling. Finally, lecithin is known to vary significantly in quality from batch to batch causing extra difficulties in food processing.

WO-A-03/095085 concerns colloidal dispersions of calcium phosphate nanoparticles and at least one protein, the size of said nanoparticles ranging between 50 and 300 nm, and the morphology of said nanoparticles being spherical. Said dispersions are prepared by a method comprising the following steps: forming a mixture comprising a calcium complexing agent such as ethylene diamine tetra-acetate (EDTA) and a calcium source, then adding to said medium at least one protein, thereafter adding thereto a phosphorus source and heating the medium. The invention also concerns nanoparticles obtained by freeze-drying said dispersion, and the particles obtained by calcining the freeze-dried nanoparticles. A major drawback of these compositions is that a calcium complexing agent such as EDTA is used. It is know that the use of EDTA makes the product particularly costly (especially for use in D&E countries) and not appealing to the consumer. Furthermore, the use of EDTA is restricted or even not allowed in some countries. Finally, such strong complexing agent like EDTA can interfere with the bioavailability of other minerals.

In many cases, the unnecessary use of emulsifiers or EDTA is not desirable. Therefore, it is desirable to develop a nutritional additive that fulfils the above-mentioned requirements for stability without the necessity of using enzymatically-decomposed lecithin or calcium complexing agents.

It is therefore an object of the present invention to provide a calcium fortified food product and calcium-containing additive, which overcomes one or more of the above mentioned drawbacks. Surprisingly, it has now been found that this object can be achieved by the food product according to the invention, having and calcium content of at least 5 ppm, comprising calcium-containing nanoparticles that are stabilised with biopolymers and, if the biopolymer is a protein, do not contain a calcium complexing agent. Preferably, the nanoparticles do not contain a calcium complexing agent, even if the biopolymer is not a protein.

### SUMMARY OF THE INVENTION

According to a first aspect, the invention provides a food product which has been fortified in calcium, having calcium content of at least 5 ppm, comprising calcium-containing nanoparticles, wherein the nanoparticles are stabilised by means of a biopolymer and, if the biopolymer is a protein, do not contain a calcium complexing agent.

According to a second aspect, there is provided an calcium containing additive for use in the food and other products according to the invention, in the form of an calcium-containing nanoparticles having a diameter of 5-1000 nanometer, wherein the nanoparticles are stabilised by means of a biopolymer and, if the biopolymer is a protein, do not contain a calcium complexing agent.

According to a third aspect, there is provided a process for preparing the calcium-containing additive of the invention and according to a fourth aspect, there is provided a process for making the food product of the invention.

### DETAILED DESCRIPTION OF THE INVENTION

The invention regards a calcium-fortified food product having a calcium content of at least 5 ppm calcium (Ca). The food product comprises calcium in the form of calcium-containing biopolymer-stabilised nanoparticles. Nanoparticles are defined for the purpose of this invention as particles stabilised by the presence of protective biopolymer. They have a particle size of about 5 to 1,000 nanometer. The compositions of the invention contain biopolymer-stabilised calcium containing nanoparticles, which have an effective average particle size of less than about 1,000 nm. In a preferred embodiment of the invention, the biopolymer stabilised calcium containing nanoparticles have an effective average particle size of less than about 900 nm, preferably less than about 800 nm, less than about 700 nm, less than about 600 nm, less than about 500 nm, less than about 400 nm, less than about 300 nm, less than about 250 nm, less than about 200 nm, less than about 150 nm, less than about 100 nm, less than about 75 nm, or even less than about 50 nm.

The effective average particle size can be measured using techniques that are well known in the art, such as electron microscopy or light scattering techniques. The nanoparticles may be crystalline, polycrystalline or amorphous.

The calcium containing nanoparticles used in the present invention are stabilised by means of a biopolymer and their derivatives, such as, polyamides (e.g. proteins and poly(amino acids)), polysaccharides (e.g. cellulose, starch and xanthan), organic polyoxoesters synthesized by bacteria and eukaryotic organisms (e.g. poly(hydroxyalkanoic acids), poly(malic acid), polylactides, polyglycolide, polyanhydrides, polyesteramides and cutin), polythioesters, polyphosphate, polyisoprenoids (e.g. natural rubber or Gutta Percha), polyphenols (e.g. lignin or humic acids), and nucleic acids such as ribonucleic acids and deoxyribonucleic acids. The most preferred biopolymers are polyamides (protein and poly(amino acids)) and polysaccharides.

The polyamide (protein) source may be any specific type of protein, e.g. animal (collagens and gelatines), in particular dairy protein, or plant protein. The plan protein sources are for example soy, pea, amaranth, canola (rape), carob, corn, oat, potato, sesame, rice, wheat, lupin protein, or mixtures thereof. These proteins can be intact or partially hydrolysed, and can be used separately or in combination with each other. The preferred protein source is whey protein or soy protein.

The polysaccharide source can be used as stabilisers, particularly polysaccharide gums. Preferred stabilisers are selected from the group of locust bean gum, tamarind seed polysaccharide, alginates, alternan, cellulose, hydroxypropylmethylcellulose (anionic), cell wall polysaccharides from fungi, chitin, chitosan, curdlan, dextran, elsinan, emulsan, gellan, glycogen, glycopeptides, seed gums, hyaluronan, inulin, levan, lipopolysaccharides and other extracellular polysaccharides, peptidoglycans from archaea and bacteria, pectin, pullulan, schizophyllan, scleroglucan, succinoglycan, starch, teichoic acids, teichuronic acids and xanthan gum, guar gum, tara gum, gum arabic, kalaya gum, carrageenan, agar soybean polysaccharides and mixtures thereof. The preferred polysaccharide source is gum arabic.

One or more auxiliary non-polysaccharide stabilisers may be used in addition to the polysaccharide stabiliser(s). In particular, examples of auxiliary stabilisers are polyvinyl pyrrolidone, glycol alginate esters, methoxy pectin (HM-pectin), sodium carboxymethylcellulose (CMC-Na), propylene glycol alginate ester (PGA) and beet-derived pectin (BD-pectin), OSA starch. These may be used alone or in combination.

Incidentally, the biopolymer can be used together with other nonionic or negatively charged surfactants. It is desired that the surfactant is usually used so as to be contained in the mineral additive of the present invention in the range of from 0 to 20% by weight.

If the stabilising biopolymer is a protein, the nanoparticles according to the present invention do not contain a calcium complexing agent such as ethylene diamine tetra-acetate (EDTA).

The amount of the biopolymer to be used may be generally about 0.01 to 10 wt. %, preferably 0.1 to 5 wt. %, and preferably around 1% wt. with respect to the total amount of non-dried product containing nanoparticles, but these ranges do not restrict the scope of the invention because they may vary depending on differences in the type of biopolymer and concentration of nanoparticles. The weight ratio of biopolymer to calcium-containing nanoparticles is generally at least about 1:10,000 or higher (e.g. more biopolymer in comparison to nanoparticle mass).

The advantages of using the biopolymer-stabilised calcium-containing nanoparticles according to the present invention are the excellent chemical stability in respect to interaction with other elements, oxidation, complexion activity, and colour change due to the low concentration of free calcium ions these than soluble calcium salts. Very importantly, due to the presence of stabilising biopolymer, these particles are compatible with many products containing other biopolymers.

Furthermore, due to their low chemical activity, these calcium containing nanoparticles allow multiple fortification with vitamins, other minerals such as Fe, Zn, Mn, Mg, Cu, Cr, Se and other micro-nutrients.

Due to their very small particle size, sedimentation is very slow or completely negligible in comparison to large particles, which provides excellent physical stability of liquid and semi-liquid products.

In addition, the nanoparticles have excellent dispersibility in aqueous phases, including emulsions and gels, and in products comprising the same.

Due to their small particle size, the mineral compositions have a good bioavailability and bioacessability in comparison to large particles of the same compound.

Due to their small size and low solubility, these substances don not cause adverse organoleptic effects, such bad (bitter) taste, chalkiness and sandiness.

Furthermore, due to their small size, these substances do not have significant abrasion effect on the equipment.

The calcium-fortified food products of the present invention can be advantageously in the form of beverages, (dry) soups, fat spreads, (yoghurt or protein) drinks, ice cream, dressings or cereal products like bread.

A second aspect of the invention is an calcium-containing additive for use in the food or other products as calcium supplement according to any one of the preceding claims, in the form of calcium containing nanoparticles of calcium insoluble inorganic or organic salt, or mixtures thereof, and having a particle size of 5 to 1000 nanometer, wherein the nanoparticles are stabilised by means of a biopolymer.

The calcium-containing additive preferably comprises a low-soluble salt having a Ks of 10 or less. By low soluble we mean a Ks, where Ks is the solubility product, of 10⁻⁷ or less.

The forms of the water-insoluble minerals generally include inorganic salts, organic salts, and the like. The inorganic salts include, for example, calcium carbonate, phosphates (e.g. Ca₃(PO₄)₂, Ca₂P₂O₇, calcium hydroxyapatite) or other inorganic insoluble calcium salts or mixtures thereof. Examples of organic low-soluble salts are calcium-partially hydrolysed proteins, Ca-sensitive polysaccharides like pectin, algenic acid, calcium phytate, fatty acids or other sufficiently low soluble organic salts of calcium. Each of those inorganic salts can be used alone or in admixture of two or more salts.

More preferably, the low-soluble calcium salt is selected from the group of calcium carbonate, calcium phosphates more preferably pyrophosphate and calcium orthophosphate or mixtures thereof.

The calcium containing food product is prepared by mixing the calcium-containing additive as dispersed in liquid or dried form using a suitable mixing process known in the art.

The amount of calcium in the food product is at least 5 ppm calcium (Ca), but preferably it is at least 10, 20, 50, 100, 300, 1,000 or even 5,000 ppm.

According to another embodiment, the calcium-containing additive is prepared by chemical homogeneous or inhomogeneous precipitation in the presence of the biopolymer or a mixture of biopolymers. The precipitation can be achieved by fast mixing, using any suitable fast mixing process, of two solutions or (liquid-in-liquid, liquid-in-gas, gas-in-liquid, or solid-in-liquid or mixtures) dispersions containing calcium ions and counter ions that form insoluble calcium salt, respectively. The biopolymer can be present in either or in both phases. The pH of the final product can be from 2 to 8, preferably between 6 and 7. Preferably, the biopolymer is present in the system containing ions that do not interact strongly with the biopolymer.

The resulting calcium-containing biopolymer-stabilised nanoparticles can be separated from the mother liquid and dried e.g. using spray or freeze drying. Or the can be concentrated or directly dried together with the side products. Preferably, the side products should be soluble salts of food acceptable ions such as Na, K, Cl, etc.

The resulting calcium-containing biopolymer-stabilised nanoparticles can be crystalline, polycrystalline or amorphous. In the preferred embodiment, the biopolymer-stabilised nanoparticles are amorphous or polycrystalline.

Finally, the additive according to the invention, comprising calcium-containing nanoparticles could be further utilized in a wide variety of fields such as cosmetics, animal feed additives, plant fertilizers, pharmaceutical products, personal and home care products.

The animal feeds containing the calcium-containing nanoparticles of the present invention include, for example, feeds for pets, domestic animals, cultured fishes, and the like.

Cosmetics containing the calcium-containing nanoparticles of the present invention include toothpaste; lotion; milky lotion; bathing agents; detergents such as cleansing agents; dentifrices, skin creams and the like.

Industrial products containing the calcium-containing nanoparticles of the present invention include calcium-based catalysts, agricultural purposes, sheet materials for walls or floors, additives to polymers and resins, inert filler, inflammable filler, for drug delivery, paper filler.

The invention will mow be further illustrated by means of the following, non-limiting examples.

### Example 1

### Whey Protein Stabilized Calcium Phosphate Nanoparticles

A solution containing 0.02M phosphate and 1% wt. whey protein isolate was prepared by dissolving sodium phosphate and whey protein isolate (trade name: BiPro 95, manufactured by Danisco Food International) in demineralized water. A calcium solution containing 0.03M Ca was prepared by dissolution of calcium chloride in demineralized water.

The calcium solution was then quickly added the phosphate-whey protein solution prepared above with vigorous stirring. The pH of the resulting mixture was not further adjusted. The reaction self-terminated after several minutes after the formation of calcium phosphate nanoparticles, a white suspension that does not sediment for several hours. The resulting reaction mixture was subjected to solid-liquid separation by centrifugation, to concentration, or to drying. The electron microscopy analyses revealed particle sizes of less than 1,000 nm. The resulting reaction mixture was subjected to solid-liquid separation by e.g. centrifugation, to concentration, or to drying.

To prepare Product I, the whey protein-stabilized calcium phosphate nanoparticles formed in the solid phase were collected and re-suspended in ion-exchanged water to give concentrated calcium phosphate slurry.

To prepare Product II, the entire reaction mixture was dried.

### Example 2

### Whey Protein Stabilized Calcium Carbonate Nanoparticles

A solution containing 0.01M carbonate and 1% wt whey protein isolate was prepared by dissolving sodium carbonate and whey protein isolate (trade name: BiPro 95, manufactured by Danisco Food International) in demineralized water. A calcium solution containing 0.01M Ca was prepared by dissolution of calcium chloride in demineralized water.

The calcium chloride solution was then quickly added the carbonate-whey protein solution prepared above with vigorous stirring. The pH of the resulting mixture was not further adjusted. The reaction self-terminated after several minutes after the formation of a white suspension of calcium carbonate nanoparticles that do not sediment for several hours. The electron microscopy analyses revealed particle sizes of less than 1,000 nm. The resulting reaction mixture was subjected to solid-liquid separation by centrifugation, to concentration, or to drying.

To prepare Product III, the whey protein-stabilized calcium carbonate nanoparticles formed in the solid phase were collected and then re-suspended in ion-exchanged water to give a concentrated calcium carbonate slurry.

To prepare Product IV, the entire reaction mixture was dried.

### Example 3

### Gum Arabic Stabilized Calcium Phosphate Nanoparticles

A solution containing 0.02M phosphate and 0.5% wt gum Arabic was prepared by dissolving sodium phosphate and Gum Arabic (manufactured by Sigma-Aldrich) in demineralized water. A calcium solution containing 0.03M Ca was prepared by dissolution of calcium chloride in demineralized water.

The calcium solution was then quickly added the phosphate-Gum Arabic solution prepared above with vigorous stirring. The pH of the resulting mixture was not further adjusted. The reaction self-terminated after several minutes after the formation of a white suspension of calcium phosphate nanoparticles that does not sediment for several hours. The electron microscopy analyses revealed particle sizes of less than 1,000 nm. The resulting reaction mixture was subjected to solid-liquid separation by centrifugation, to concentration, or to drying.

To prepare Product V, the Gum Arabic-stabilized calcium phosphate nanoparticles formed in the solid phase were collected and the resulting complex was then re-suspended in ion-exchanged water to give a concentrated calcium phosphate slurry.

To prepare Product VI, the entire reaction mixture was dried.

### Example 4

### Gum Arabic Stabilized Calcium Carbonate Nanoparticles

A solution containing 0.01M carbonate and 0.5% wt gum Arabic was prepared by dissolving sodium carbonate and Gum Arabic (manufactured by Sigma-Aldrich) in demineralized water. A calcium solution containing 0.01M Ca was prepared by dissolution of calcium chloride in demineralized water.

The calcium solution was then quickly added the carbonate-Gum Arabic solution prepared above with vigorous stirring. The pH of the resulting mixture was not further adjusted. The reaction self-terminated after several minutes after the formation of a white suspension of calcium carbonate nanoparticles that does not sediment for several hours. The electron microscopy analyses revealed particle sizes of less than 1,000 nm. The resulting reaction mixture was subjected to solid-liquid separation by centrifugation, to concentration, or to drying.

To prepare Product VII, the Gum Arabic-stabilized calcium carbonate nanoparticles formed in the solid phase were collected, and the resulting complex was then re-suspended in ion-exchanged water to give a concentrated calcium carbonate slurry.

To prepare Product VIII, the entire reaction mixture was dried.

1. Food product which has been fortified in calcium content, having an calcium content of at least 5 ppm, comprising calcium containing nanoparticles, wherein the nanoparticles are stabilised by means of a biopolymer and, if the biopolymer is a protein, do not contain a calcium complexing agent.

2. Food product according to claim 1, wherein the nanoparticles comprise a low-soluble calcium salt having a Ks of 10⁻⁷ or less.

3. Food product according to claim 2, wherein said low-soluble calcium salts is an inorganic salt selected from the group calcium carbonate, phosphates (e.g. Ca₃(PO₄)₂, Ca₂P₂O₇, hydroxyapatite) or other inorganic insoluble calcium salts or mixtures thereof.

4. Food product according to claim 2, wherein said low-soluble calcium salts is selected from the group consisting of organic low-soluble salts of calcium with partially hydrolysed proteins, phytate, organic acids, or other sufficiently low soluble organic salts of calcium.

5. Food product according to claim 1, comprising a mixture of inorganic and organic salts.

6. Food product according to claim 1, wherein the biopolymer is selected from the group of polyamides, polysaccharides, organic polyoxoesters synthesized by bacteria and eukaryotic organisms, poly(malic acid), polylactides, polyglycolide, polyanhydrides, polyesteramides and cutin, polythioesters, polyphosphate, polyisoprenoids, polyphenols, and nucleic acids.

7. Food product according to claim 1, wherein the biopolymer is a protein, a poly(amino acid), a polysaccharide or mixtures thereof.

8. Food product according to claim 7, wherein the biopolymer is a protein.

9. Food product according to claim 8, wherein the protein is selected from the group consisting of soy protein, whey protein and casein.

10. Food product according to claim 7, wherein the biopolymer is a polysaccharide, preferably a gum.

11. Food product according to claim 1, the form of fat spread, a (protein) drink, an instant protein drink, a beverage or a dressing.

12. Calcium-containing additive for use in the food or other products according to claim 1, in the form of calcium containing nanoparticles having a particle size of 5 to 1,000 nanometer, wherein the nanoparticles are stabilised by means of a biopolymer and, if the biopolymer is a protein, do not contain a calcium complexing agent.

13. Calcium-containing additive according to claim 12, wherein the nanoparticles comprise a low-soluble calcium salt having a Ks of 10⁻⁷ or less.

14. Calcium-containing additive according to claim 13, wherein said low-soluble calcium salt is selected from the group consisting of low-soluble calcium inorganic salts selected from the group of calcium carbonate, phosphates (e.g. Ca₃(PO₄)₂, Ca₂P₂O₇, hydroxyapatite) or other inorganic insoluble calcium salts or mixtures thereof.

15. Calcium-containing additive according to claim 13, wherein said calcium salt is selected from the group consisting of low-soluble calcium inorganic salts of organic such low-soluble salts of calcium with partially hydrolysed proteins, phytate, organic acids, or other sufficiently low soluble organic salts of calcium.

16. Calcium-containing additive according to claim 12, comprising a mixture of inorganic and organic salts.

17. Calcium-containing additive according to claim 12, wherein the biopolymer is selected from the group consisting of polyamides, polysaccharides, organic polyoxoesters synthesized by bacteria and eukaryotic organisms, poly(malic acid), polylactides, polyglycolide, polyanhydrides, polyesteramides and cutin, polythioesters, polyphosphate, polyisoprenoids, polyphenols and nucleic acids.

18. Calcium-containing additive according to claim 17, wherein the biopolymer is a protein.

19. Calcium-containing additive according to claim 18, wherein the protein is selected from the group consisting of soy protein, whey protein and casein.

20. Calcium-containing additive according to claim 12, wherein the biopolymer is a polysaccharide.

21. Calcium-containing additive according to claim 12, wherein said polysaccharide is selected from the group consisting of locust bean gum, tamarind seed polysaccharide, gellan gum, xanthan gum, guar gum, tara gum, gum arabic, kalaya gum, carrageenan, agar soybean polysaccharides and mixtures thereof.

22. Calcium-containing additive according to claim 12, further comprising an auxiliary non-polysaccharide stabilizer selected from the group consisting of glycol alginate esters, methoxy pectin (HM-pectin), sodium carboxymethylcellulose (CMC-Na), propylene glycol alginate ester (PGA), and beet-derived pectin (BD-pectin), starch, OSA starch or combinations thereof.

23. Process for preparing the food product according to claim 1, comprising the steps of adding or mixing the calcium-containing additive in solid or dispersed form with the food products.

24. Calcium-containing additive according to claim 12, wherein the low-soluble calcium salt is obtained by a method for forming salts by homogeneous, heterogeneous or mixed precipitation and in the presence of a biopolymer.
